(19) United States
(12) Patent Application Publication
(10) Pub. No.: US 2005/0084097 A1
(43) Pub. Date: Apr. 21, 2005

(54) APPARATUS AND METHOD FOR CALCULATINGTKIP SBOX VALUE

(76) Inventors: Tien-Shin Ho, Taipei Hsien (TW); Hsin-I Chou, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,659

(22) Filed: Oct. 16, 2003

(51) Int. Cl. H04L 9/00

(52) U.S. Cl. 380/28

(57) ABSTRACT

An input port for receiving the 16-bit index value is connected to a plurality of combinatorial logic. The plurality of combinatorial logic directly calculates the TKIP Sbox value based on the index and outputs the TKIP Sbox value on an output port. The plurality of combinatorial logic has a first plurality of combinatorial logic connected to a low part of the index value for calculating a TKIP Sbox left value and a second plurality of combinatorial logic connected to a high part of the index value for calculating a TKIP Sbox right value. The TKIP Sbox value is formed by XORing the TKIP Sbox left value and the TKIP Sbox right value.

### BACKGROUND OF INVENTION

1. Field of the Invention

The invention relates to the temporal key integrity (TKIP) protocol for wireless networks as specified by the IEEE 802.11i standard, and more particularly, to calculating the TKIP Sbox value required by the key mixing functions in the TKIP protocol.

2. Description of the Prior Art

The IEEE Standard 802.11 specifies protocols defining a wireless local area network (WLAN). This standard defines an Ethernet-like communication channel using radio signals instead of wired signals, providing an unreliable datagram medium. Although noise commonly associated with radio signals results inhigh packet loss rates, with the combination of robust communication protocols like TCP/IP andthe high bandwidth of 802.11, WLAN provides a reliable network and shields users from the underlying problems of radio signals such as radio interference, signal reflections, and signal attenuation. In general, WLANs are faster to setup, more flexible, and less costly than running cables in a wired network. For these reasons, the growth of WLAN has been very rapid.

The IEEE 802.11 standard divides a wireless LAN into two logical layers. The first layer is the Physical media sub-layer (PHY) controlling the particular frequency and modulation methods used for the radio signals. Different variations of the IEEE 802.11 standard specify different PHY sub-layers. For example, 802.11b (WiFi) uses a PHY sub-layer at 2.4 GHz and provides a maximum bandwidth of 11 Mbps. The second logical layer specified by the IEEE 802.11 standard is the Media Access Control sub-layer (MAC). Because radio signals broadcast by a particular station in a WLAN can be received by unintended receivers and there is no accurate way to know from which station a radio transmission originates, security is of utmost importance in a WLAN. Among other items, the MAC sub-layer provides for this security requirement.

The original IEEE 802.11 standard used the Wired Equivalency Protocol (WEP) as the security protocol. The goal of WEP was to provide security for a wireless network equivalent to the security inherent in a wired network. As WEP is a part of the IEEE 802.11 specification, all earlier IEEE 802.11 compliant devices implement this protocol. Unfortunately WEP falls short of its goal of providing adequate security and suffers from fatal weaknesses including: accepting forged packets as valid, accepting replayed packets as valid, and misusing RC4 encryption. A task group was created to address these problems and provide an updated protocol that provides better security.

The result of this effort is the temporal key integrity protocol (TKIP) and is described in the IEEE 802.11i standard as a mandatory to implement update to the original WLAN specification. In order to make it easier to implement TKIP on legacy equipment already deployed, TKIP acts a wrapper around the old WEP protocol. TKIP provides a message authentication code, referred to as Michael, to defeatforgeries; a packet sequence number (the WEP IV field) to defeat replayed packets; and key mixing to correct WEPs misuse of the RC4 encryption.

The TKIP key mixing function creates a new per-packet key construction by substituting a temporal key for the WEP base key. Temporal keys have a short period of use and are frequently replaced. When creating a new per-packet key construction, an intermediate key is first produced by combining the 802 MAC address of the local wireless interface and the temporal key by iteratively XORing each of their bytes to index into an S-box. This allows different stations to generate differentintermediate keys, even if they begin from the same temporal key. In order to determine the intermediate key, each station includes an S-box with a 64K bit lookup table implemented as two 256-entry byte wide tables.

Please refer to the following code listing for calculating the TKIP Sbox value according to an Sbox lower code table and an Sbox upper code table according to the IEEE 802.11i standard.

Line 14 /
***********************************************************
*/
Line 15 /* tkip_sbox( ) */
Line 16 /* Returns a 16 bit value from a 64K entry table.
The Table */
Line 17 /* is synthesized from two 256 entry byte wide
tables. */
Line 18 /
***********************************************************
*/
Line 19
Line 20 unsigned int tkip_sbox(unsigned int index)
Line 21 {
Line 22 unsigned int index_low;
Line 23 unsigned in index_high;
Line 24 unsigned int left, right;
Line 25
Line 26 index_low = (index % 256);
Line 27 index_high = ((index >> 8) % 256);
Line 28
Line 29 left = Tkip_Sbox_Lower[index_low] +
Line 30 (Tkip_Sbox_Upper[index_low] * 256);
Line 31 right = Tkip_Sbox_Upper[index_high] +
Line 32 (Tkip_Sbox_Lower[index_high] * 256);
Line 33
Line 34 return (left \hat{ } right);
Line 35 };
unsigned int Tkip_Sbox_Lower[256] =
{
0xA5,0x84,0x99,0x8D,0x0D,0xBD,0xB1,0x54,
0x50,0x03,0xA9,0x7D,0x19,0x62,0xE6,0x9A,
0x45,0x9D,0x40,0x87,0x15,0xEB,0xC9,0x0B,
0xEC,0x67,0xFD,0xEA,0xBF,0xF7,0x96,0x5B,
0xC2,0x1C,0xAE,0x6A,0x5A,0x41,0x02,0x4F,
0x5C,0xF4,0x34,0x08,0x93,0x73,0x53,0x3F,
0x0C,0x52,0x65,0x5E,0x28,0xA1,0x0F,0xB5,
0x09,0x36,0x9B,0x3D,0x26,0x69,0xCD,0x9F,
0x1B,0x9E,0x74,0x2E,0x2D,0xB2,0xEE,0xFB,
0xF6,0x4D,0x61,0xCE,0x7B,0x3E,0x71,0x97,
0xF5,0x68,0x00,0x2C,0x60,0x1F,0xC8,0xED,
0xBE,0x46,0xD9,0x4B,0xDE,0xD4,0xE8,0x4A,
0x6B,0x2A,0xE5,0x16,0xC5,0xD7,0x55,0x94,
0xCF,0x10,0x06,0x81,0xF0,0x44,0xBA,0xE3,
0xF3,0xFE,0xC0,0x8A,0xAD,0xBC,0x48,0x04,
0xDF,0xC1,0x75,0x63,0x30,0x1A,0x0E,0x6D,
0x4C,0x14,0x35,0x2F,0xE1,0xA2,0xCC,0x39,
0x57,0xF2,0x82,0x47,0xAC,0xE7,0x2B,0x95,
0xA0,0x98,0xD1,0x7F,0x66,0x7E,0xAB,0x83,
0xCA,0x29,0xD3,0x3C,0x79,0xE2,0x1D,0x76,
0x3B,0x56,0x4E,0x1E,0xDB,0x0A,0x6C,0xE4,
0x5D,0x6E,0xEF,0xA6,0xA8,0xA4,0x37,0x8B,
0x32,0x43,0x59,0xB7,0x8C,0x64,0xD2,0xE0,
0xB4,0xFA,0x07,0x25,0xAF,0x8E,0xE9,0x18,
0xD5,0x88,0x6F,0x72,0x24,0xF1,0xC7,0x51,
0x23,0x7C,0x9C,0x21,0xDD,0xDC,0x86,0x85,
0x90,0x42,0xC4,0xAA,0xD8,0x05,0x01,0x12,
0xA3,0x5F,0xF9,0xD0,0x91,0x58,0x27,0xB9,
0x38,0x13,0xB3,0x33,0xBB,0x70,0x89,0xA7,
0xB6,0x22,0x92,0x20,0x49,0xFF,0x78,0x7A,
0x8F,0xF8,0x80,0x17,0xDA,0x31,0xC6,0xB8,
0xC3,0xB0,0x77,0x11,0xCB,0xFC,0xD6,0x3A
};
unsigned int Tkip_Sbox_Upper[256] =
{
0xC6,0xF8,0xEE,0xF6,0xFF,0xD6,0xDE,0x91,
0x60,0x02,0xCE,0x56,0xE7,0xB5,0x4D,0xEC,
0x8F,0x1F,0x89,0xFA,0xEF,0xB2,0x8E,0xFB,
0x41,0xB3,0x5F,0x45,0x23,0x53,0xE4,0x9B,
0x75,0xE1,0x3D,0x4C,0x6C,0x7E,0xF5,0x83,
0x68,0x51,0xD1,0xF9,0xE2,0xAB,0x62,0x2A,
0x08,0x95,0x46,0x9D,0x30,0x37,0x0A,0x2F,
0x0E,0x24,0x1B,0xDF,0xCD,0x4E,0x7F,0xEA,
0x12,0x1D,0x58,0x34,0x36,0xDC,0xB4,0x5B,
0xA4,0x76,0xB7,0x7D,0x52,0xDD,0x5E,0x13,
0xA6,0xB9,0x00,0xC1,0x40,0xE3,0x79,0xB6,
0xD4,0x8D,0x67,0x72,0x94,0x98,0xB0,0x85,
0xBB,0xC5,0x4F,0xED,0x86,0x9A,0x66,0x11,
0x8A,0xE9,0x04,0xFE,0xA0,0x78,0x25,0x4B,
0xA2,0x5D,0x80,0x05,0x3F,0x21,0x70,0xF1,
0x63,0x77,0xAF,0x42,0x20,0xE5,0xFD,0xBF,
0x81,0x18,0x26,0xC3,0xBE,0x35,0x88,0x2E,
0x93,0x55,0xFC,0x7A,0xC8,0xBA,0x32,0xE6,
0xC0,0x19,0x9E,0xA3,0x44,0x54,0x3B,0x0B,
0x8C,0xC7,0x6B,0x28,0xA7,0xBC,0x16,0xAD,
0xDB,0x64,0x74,0x14,0x92,0x0C,0x48,0xB8,
0x9F,0xBD,0x43,0xC4,0x39,0x31,0xD3,0xF2,
0xD5,0x8B,0x6E,0xDA,0x01,0xB1,0x9C,0x49,
0xD8,0xAC,0xF3,0xCF,0xCA,0xF4,0x47,0x10,
0x6F,0xF0,0x4A,0x5C,0x38,0x57,0x73,0x97,
0xCB,0xA1,0xE8,0x3E,0x96,0x61,0x0D,0x0F,
0xE0,0x7C,0x71,0xCC,0x90,0x06,0xF7,0x1C,
0xC2,0x6A,0xAE,0x69,0x17,0x99,0x3A,0x27,
0xD9,0xEB,0x2B,0x22,0xD2,0xA9,0x07,0x33,
0x2D,0x3C,0x15,0xC9,0x87,0xAA,0x50,0xA5,
0x03,0x59,0x09,0x1A,0x65,0xD7,0x84,0xD0,
0x82,0x29,0x5A,0x1E,0x7B,0xA8,0x6D,0x2C
};

In the code listing, at line 26 and line 27, a 16-bit index is separated in to index_high and index_low. Line 29 determines a left value and involves two table lookups indexed by the index_low. Line 31 determines a right value and involves two table lookups indexed by the index_high. A memory device such as a mask ROM is used to store the Sbox lower code table (Tkip_Sbox_Lower) and the Sbox upper code table (Tkip_Sbox_Upper). The problem with this solution is that mask ROMs are physically large in size and if implemented on-chip require a large amount of chip space. For this reason, mask ROMs are normally implemented as an external component. In todays competitive market place, there is a trend of moving toward providing a complete system on a single chip and reducing external components whenever possible. There remains a need for a smaller implementation of the Sbox function that can be efficiently implemented inside an IC.

### SUMMARY OF INVENTION

It is therefore a primary objective of the claimed invention to provide a TKIP Sbox function having a smaller on-chip area, to solve the above-mentioned problem.

According to the claimed invention, an apparatus is disclosed for calculating the a TKIP Sbox value required by the TKIP Sbox function described in the IEEE P802.11i specification. The apparatus comprises a first plurality of combinatorial logic for calculating a TKIP Sbox left value according to a low part of an index value, a second plurality of combinatorial logic for calculating a TKIP Sbox right value according to a high part of the index value, and a third plurality of combinatorial logic for calculating the TKIP Sbox value according to the TKIP Sbox left value and the TKIP Sbox right value.

Also according to the claimed invention, a method is disclosed for calculating a TKIP Sbox value required by the TKIP Sbox function described in the IEEE P802.11i specification. The method comprises the following steps: calculating a TKIP Sbox left value according to a first part of an index value, calculating a TKIP Sbox right value according to a second part of the index value, and calculating the TKIP Sbox value according to the TKIP Sbox left value and the TKIP Sbox right value.

Also according to the claimed invention, an apparatus is disclosed for calculating a TKIP Sbox value required by a TKIP Sbox function, the apparatus comprising a TKIP Sbox logic configured to calculate a TKIP Sbox value according to an index value.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an apparatus for calculating the TKIP Sbox value according to the present invention.

FIG. 2 is an internal implementation of the plurality of combinatorial logic of FIG. 4.

FIG. 3 is an example of a logic circuit for calculating the I₀ bit in FIG. 2.

FIG. 4 is a flowchart illustrating a method for calculating the TKIP Sbox value according the present invention.

### DETAILED DESCRIPTION

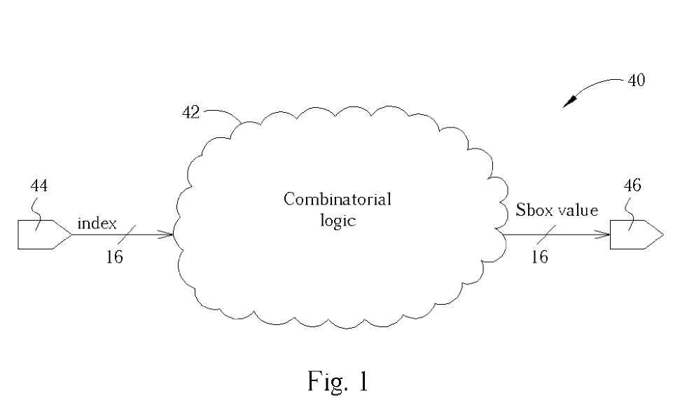

FIG. 1 shows an apparatus 40 for calculating the TKIP Sbox value according to the present invention. The apparatus 40 includes an input port 44 for receiving the 16-bit index value, a plurality of combinatorial logic 42, and an output port 46 for outputting the 16-bit TKIP Sbox value. The plurality of combinatorial logic 42 calculates the TKIP Sbox value based on the index, avoiding the use of the mask ROM required in the prior art. In contrast to the prior art, which stores pre-calculated Sbox values in a mask ROM, the present invention calculates the TKIP Sbox value based on the index value. By using combinatorial logic to calculate the TKIP Sbox value, a typical space savings of 66% is achieved when compared to the prior art using a mask ROM to lookup a pre-calculated value. As IC area is directly proportional to IC cost, when implemented in an IC, this space savings greatly reduces the overall cost of the design. Furthermore, combinatorial logic calculates the TKIP Sbox value faster than a ROM lookup and requires less power than a mask ROM implementation.

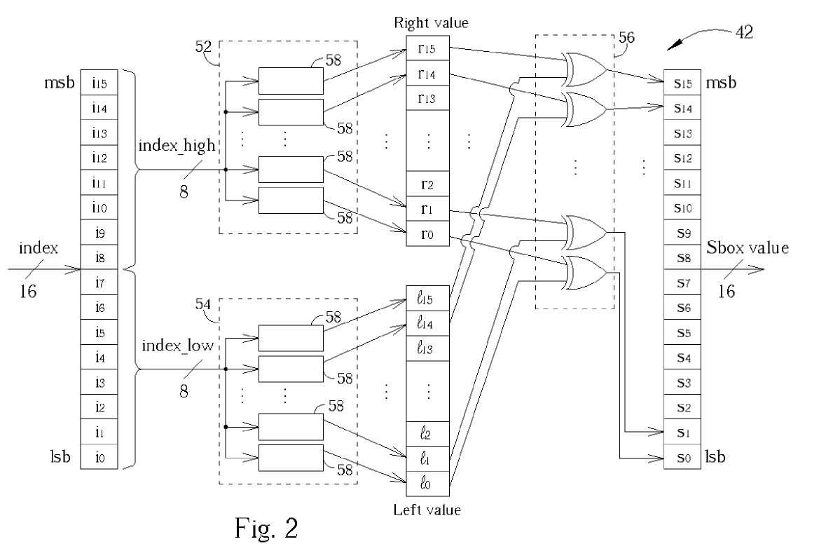

FIG. 2 shows an internal implementation of the plurality of combinatorial logic 42 shown in FIG. 1. The plurality of combinatorial logic 42 includes a first plurality of combinatorial logic 52, a second plurality of combinatorial logic 54, and a plurality of XOR gates 56. The first plurality of combinatorial logic 52 is connected to the eight most significant bits of the index (i₁₅ to i₈), referred to as index_high; and the second plurality of combinatorial logic 54 is connected to the eight least significant bits of the index (i₇ to i₀), referred to as index_low. The first plurality of combinatorial logic 52 contains sixteen logic circuits, i.e. one logic circuit 58 for calculating each bit in a right value (r₁₅ to r₀). Similarly, the second plurality of combinatorial logic 54 contains sixteen logic circuits, i.e. one logic circuit 58 for calculating each bit in a left value(l₁₅ to l₀). The plurality of XOR gates 56 is used to exclusive-or the right value with the left value to form the Sbox value. Specifically, the least significant bit in the right value r₀ is XORed with the least significant bit in the left value l₀ and the result forms the least significant bit in the Sbox value s₀. Likewise, r₁ is XORed with l₁ to form s_{1,} r₂ is XORed with l₂ to form s₂, and so on with r₁₅ being XORed with l₁₅ to form s₁₅.

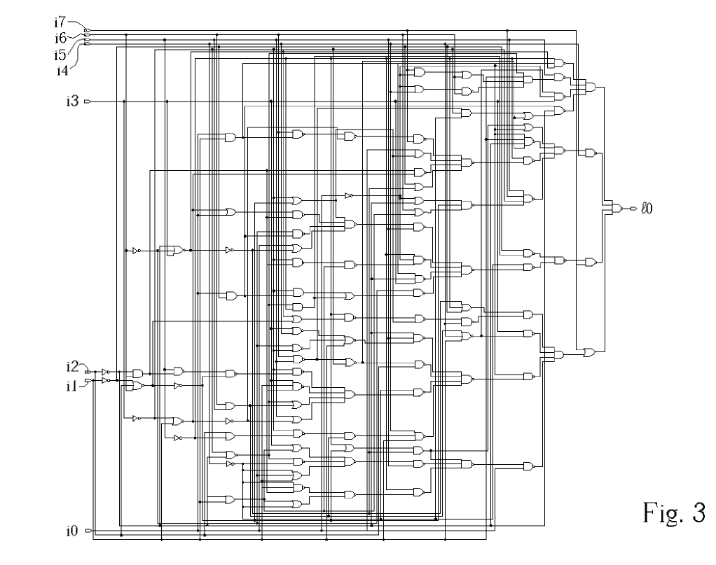

FIG. 3 shows an example logic circuit 60 for calculating the least significant bit of the left value l₀. The example logic circuit 60 uses the bits (i₇ to i₀) in index_low to calculate the bit l₀ of the left value. The logic circuit 60 shown in FIG. 3 is only one of a plurality of possible logic circuits. Any logic circuit that calculates the correct value according to the TKIP Sbox Lower table and the TKIP Sbox Upper table shown above for each bit in the left value (l₁₅ to l₀) and the right value (r₁₅ to r₀) can be used. It should also be noted that depending on process requirements and device availability, different logic circuits including different logic gates can be used. The example logic circuit 60 shown in FIG. 3 comprises NOT-gates, NAND-gates, and NOR gates as these are common gates used in most ICs.

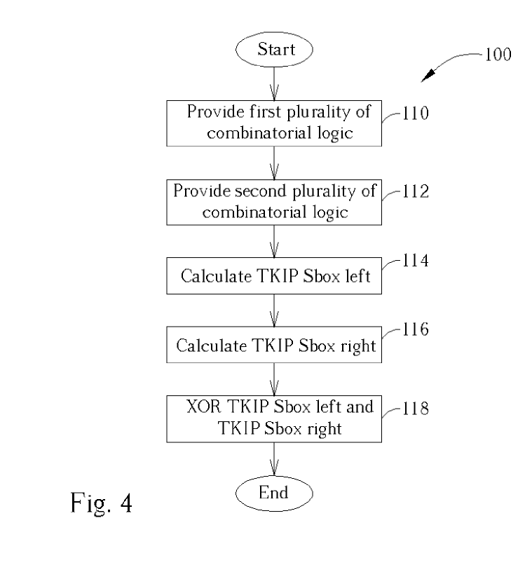

FIG. 4 shows a flowchart 100 illustrating a method for calculating the TKIP Sbox value according the present invention. The flowchart 100 includes the following steps:

Step 110: Provide a first plurality of combinatorial logic including sixteen logic circuits connected to the eight most significant bits of the index, and proceed to step 112.

Step 112: Provide a second plurality of combinatorial logic including sixteen logic circuits connected to the eight least significant bits of the index, and proceed to step 114.

Step 114: Calculate a TKIP Sbox left value using the first plurality of combinatorial logic. Each logic circuit in the first plurality of combinatorial logic respectively calculates a bit in the TKIP Sbox left value. Proceed to step 116.

Step 116: Calculate a TKIP Sbox right value using the second plurality of combinatorial logic. Each logic circuit in the second plurality of combinatorial logic respectively calculates a bit in the TKIP Sbox right value. Proceed to step 118.

Step 118: Calculate the TKIP Sbox value by XORing the TKIP Sbox left value with the TKIP Sbox right value.

In contrast to the prior art, the present invention uses a plurality of combinatorial logic to directly calculate the TKIP Sbox value based on the index. In this way, the use of the mask ROM required in the prior art is avoided. By using combinatorial logic to calculate the TKIP Sbox value, a space savings of 66 % is achieved, the TKIP Sbox value is calculated faster, and the power requirements of the circuit are reduced.

Those skilled in the art will readily observe that numerous modifications and alterations of the device may be made while retaining the teachings of the invention. Accordingly, that above disclosure should be construed as limited only by the metes and bounds of the appended claims.

1. An apparatus for calculating a TKIP Sbox value required by the TKIP Sbox function described in the IEEE P802.11i specification, the apparatus comprising:
a first plurality of combinatorial logic for calculating a TKIP Sbox left value according to a low part of an index value;
a second plurality of combinatorial logic for calculating a TKIP Sbox right value according to a high part of the index value; and
a third plurality of combinatorial logic for calculating the TKIP Sbox value according to the TKIP Sbox left value and the TKIP Sbox right value.

2. The apparatus of claim 1, wherein the third plurality of combinatorial logic is a plurality of XOR gates.

3. The apparatus of claim 2, wherein the TKIP Sbox left value is XORed with the TKIP Sbox right value by the plurality of XOR gates and the output of the plurality of XOR gates forms the TKIP Sbox value.

4. The apparatus of claim 1, wherein for each bit in the TKIP Sbox left value, the first plurality of combinatorial logic comprises a logic circuit, each logic circuit respectively calculating a bit in the TKIP Sbox left value.

5. The apparatus of claim 1, wherein for each bit in the TKIP Sbox right value, the second plurality of combinatorial logic comprises a logic circuit, each logic circuit respectively calculating a bit in the TKIP Sbox right value.

6. A method for calculating a TKIP Sbox value required by the TKIP Sbox function described in the IEEE P802.11i specification, the method comprising the following steps:
calculating a TKIP Sbox left value according to a first part of an index value;
calculating a TKIP Sbox right value according to a second part of the index value; and
calculating the TKIP Sbox value according to the TKIP Sbox left value and the TKIP Sbox right value.

7. The method of claim 6, wherein the step of calculating the TKIP Sbox value comprises:
performing an exclusive-or of the TKIP Sbox left value and the TKP Sbox right value to form the TKIP Sbox value.

8. The method of claim 6, wherein the step of calculating the TKIP Sbox left value further comprising calculating each bit in the TKIP Sbox left value according to the first part of an index value.

9. The method of claim 6, wherein the step of calculating the TKIP Sbox right value further comprising calculating each bit in the TKIP Sbox right value according to the second part of an index value.

10. An apparatus for calculating a TKIP Sbox value required by a TKIP Sbox function, the apparatus comprising:
a TKIP Sbox logic configured to calculate a TKIP Sbox value according to an index value.

11. The apparatus of claim 10, wherein the TKIP Sbox logic further comprises:
a first plurality of combinatorial logic for calculating a TKIP Sbox left value according to a first part of the index value;
a second plurality of combinatorial logic for calculating a TKIP Sbox right value according to a second part of the index value; and
a third plurality of combinatorial logic for calculating the TKIP Sbox value according to the TKIP Sbox left value and the TKIP Sbox right value.

12. The apparatus of claim 11, wherein the third plurality of combinatorial logic is a plurality of XOR gates.

13. The apparatus of claim 12, wherein the TKIP Sbox left value is XORed with the TKIP Sbox right value by the plurality of XOR gates and the output of the plurality of XOR gates forms the TKIP Sbox value.

14. The apparatus of claim 11, wherein for each bit in the TKIP Sbox left value, the first plurality of combinatorial logic comprises a logic circuit, each logic circuit respectively calculating a bit in the TKIP Sbox left value.

15. The apparatus of claim 11, wherein for each bit in the TKIP Sbox right value, the second plurality of combinatorial logic comprises a logic circuit, each logic circuit respectively calculating a bit in the TKIP Sbox right value.
